(19) United States
(12) Patent Application Publication
(10) Pub. No.: US 2008/0246306 A1
(43) Pub. Date: Oct. 9, 2008

(54) Wind Deflector For a Motor Vehicle

(76) Inventors: Philipp Oerke, Munich (DE); Rainer Mathias, Tutzing (DE); Dominik Holzel, Grobenzell (DE)

Correspondence Address: DICKINSON WRIGHT PLLC, 1901 L. STREET NW, SUITE 800, WASHINGTON, DC, 20036, US

(21) Appl. No.: 12/093,523

(22) PCT Filed: Nov. 13, 2006
(86) PCT No.: PCT/DE2006/001976

§ 371 Date: Jun. 20, 2008

(30) Foreign Application Priority Data
Nov. 14, 2005 (DE) 10 2005 054 186.0

(51) Int. Cl. B62D 37/02

(52) U.S. Cl. 296/180.1

(57) ABSTRACT

The present invention relates to a wind deflector (1) in the motor vehicle sector, with a base element (2) which can be mounted on a part of a motor vehicle, with an opener (3) which is pivotally coupled to the base element (2), with an adjusting device (4) for pivoting the opener (3) between a stowed position and an opened-out position, and with a deflector element (5) which can be mounted on the base element (2) and on the opener (3) for the purpose of clamping the deflector element (5) therebetween when the opener (3) is in the opened-out position, wherein the deflector element (5) can be fastened to the base element (2) and/or to the opener (3) by means of a detachable connection.

The present invention relates to a wind deflector in the motor vehicle sector.

Although usable in any desired regions of a motor vehicle, the present invention and the problem on which it is based are explained in more detail with respect to a sliding roof of a motor vehicle. The present inventive concept can also be used, for example, on put-up roofs or sun roofs of a vehicle.

A problem which is generally known in the case of a motor vehicle sliding roof is that, when the cover is open, periodic pressure fluctuations may occur in the interior of the vehicle when the vehicle is moving at low to medium speeds. Said periodic pressure fluctuations are primarily noticeable acoustically in the form of “booming”. To avoid said pressure fluctuations, use is generally made of wind deflectors.

A wind deflector generally has the function of improving the flow conditions of the motor vehicle when, for example, the cover of a sliding roof is in an open position. The wind deflector is usually arranged at the front end, as seen in the direction of travel, of the roof opening opened up by the cover, and is transferred from a retracted position, in which it is located below the outer surface of the vehicle roof, into a deployed position when the cover is opened.

The publication DE 102 10 142 A1 discloses a wind deflector for a vehicle roof, the wind deflector having a base element which is provided for attachment to the vehicle roof. Furthermore, the wind deflector comprises a deployment element which is connected pivotably to the base element. Also provided are an air-permeable deflector element on the base element and on the deployment element, and at least one deployment spring which presses the deployment element into a deployed position in which the deflector element is tensioned between the base element and the deployment element. In this case, the deflector element is fixedly injected into the base element and into the deployment element.

However, a disadvantage of this approach according to the prior art is that the wind deflector is designed as a single-part structural element and this is disadvantageous in terms of installation because of the limited installation space. Furthermore, an injection of the deflector element into the base element and into the deployment element is extremely complicated, since the molds required for this purpose have to be designed with very great precision. In the case of a change to the construction of the wind deflector, a very complicated rearrangement of the mold is disadvantageously necessary.

Furthermore, in the event of the deflector element being damaged or having to be replaced for another reason, the entire deflector element has to be removed and a new deflector element fitted. This is associated with a high outlay on maintenance and high maintenance costs.

The present invention is based on the object of eliminating the abovementioned disadvantages and, in particular, of providing a wind deflector which can be attached to the base element and/or to the deployment element in a simpler and more advantageous manner.

This object is achieved according to the invention by the wind deflector with the features of patent claim 1.

The idea on which the present invention is based consists in that the wind deflector has a base element which can be attached to a motor vehicle part; a deployment element which is coupled pivotably to the base element; an adjusting device for pivoting the deployment element between a storage position and a deployed position; and a deflector element which can be attached to the base element and to the deployment element in order to tension the deflector element between the same in the deployed position of the deployment element; wherein the deflector element can be attached to the base element and/or to the deployment element by means of a releasable connection.

The present invention therefore has the advantage over the known approaches according to the prior art that the deflector element can be attached to the base element and/or to the deployment element without a disadvantageous injection process. The deflector element can be connected to the base element and/or to the deployment element in a simple manner in terms of installation and, in the event of possible damage to the deflector element, can be replaced in a simple and cost-effective manner.

Advantageous refinements and improvements of the wind deflector indicated in patent claim 1 are found in the sub-claims.

According to a preferred development, the deflector element can be releasably attached directly to the base element and/or to the deployment element by means of a clamping device.

For example, the clamping device is designed as a plastic part with a film hinge injection-molded onto it in order to form a clamping strip. As a result, the deflector element can be clamped in the clamping device in a simple manner without complicated injection-molding processes being necessary.

As an alternative, the clamping device can be designed as a two-part clamping part for clamping the deflector element between the two individual parts. The two individual parts can preferably be joined together, for example by means of plugging together, clamping or the like, in order to clamp the deflector element between the two individual parts. It is advantageous for the one individual part of the clamping device to have receiving holes and for the other individual part of the clamping device to have plug-in pins, it being possible for the plug-in pins to be plugged into associated receiving holes in order to clamp the deflector element between the same.

The clamping device can also be designed, for example, as a clamping strip which can be plugged on and/or can be pushed in, for clamping the deflector element between the clamping strip and the structural element or the deployment element.

According to a further preferred development, the deflector element can be releasably fastened to the base element and/or to the deployment element indirectly via a connecting element. In this case, the deflector element can be fixedly sewn, adhesively bonded, welded, injection-molded or the like to the connecting element. As an alternative, however, the deflector element can also be releasably fastened to the connecting element, for example by means of clamping or the like.

According to a further preferred exemplary embodiment, the connecting element in turn can be releasably attached to the base element and/or to the deployment element by means of a plug-in connection, clamping connection, wedge action connection, expanding connection, retaining connection, latching connection or the like.

The deflector element can therefore be attached to the respective connecting element in a simple and cost-effective manner before the wind deflector is installed, with it also being possible for the connecting element to be releasably connected to the base element and to the deployment element in the installation state thereof.

The invention is explained in more detail below using exemplary embodiments and with reference to the attached figures of the drawing.

Of the figures:

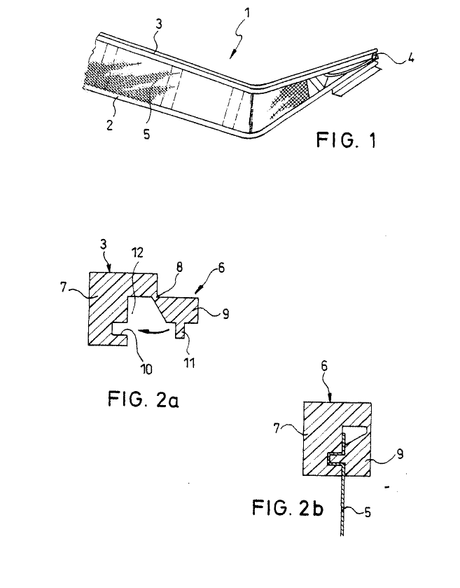

FIG. 1 shows a partial view of a wind deflector according to an exemplary embodiment of the present invention in a perspective illustration;

FIG. 2a shows a cross-sectional view of a connecting device according to a first preferred exemplary embodiment of the present invention in an open position;

FIG. 2b shows a cross-sectional view of the connecting device from FIG. 2a in a closed position with the deflector element clamped;

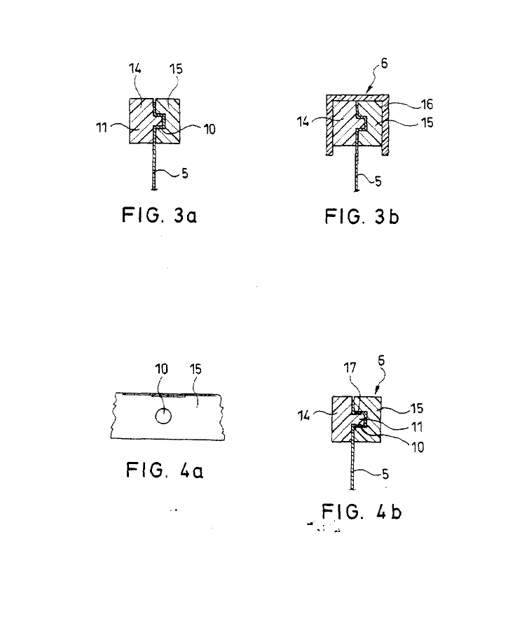

FIG. 3a shows a cross-sectional view of a connecting device according to a second preferred exemplary embodiment of the present invention in the non-locked state;

FIG. 3b shows a cross-sectional view of the connecting device from FIG. 3a in the locked state;

FIG. 4a shows a front view of a component of a connecting device according to a third preferred exemplary embodiment of the present invention;

FIG. 4b shows a cross-sectional view of the connecting device according to the third preferred exemplary embodiment of the present invention;

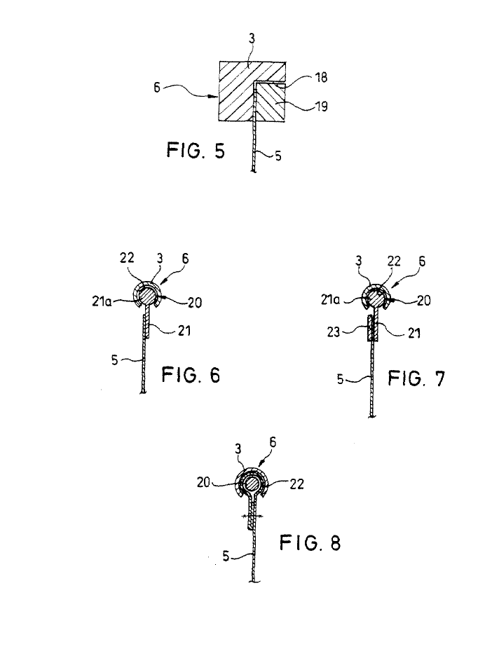

FIG. 5 shows a cross-sectional view of a connecting device according to a fourth preferred exemplary embodiment of the present invention;

FIG. 6 shows a cross-sectional view of a connecting device according to a fifth preferred exemplary embodiment of the present invention;

FIG. 7 shows a cross-sectional view of a connecting device according to a sixth preferred exemplary embodiment of the present invention;

FIG. 8 shows a cross-sectional view of a connecting device according to a seventh preferred exemplary embodiment of the present invention;

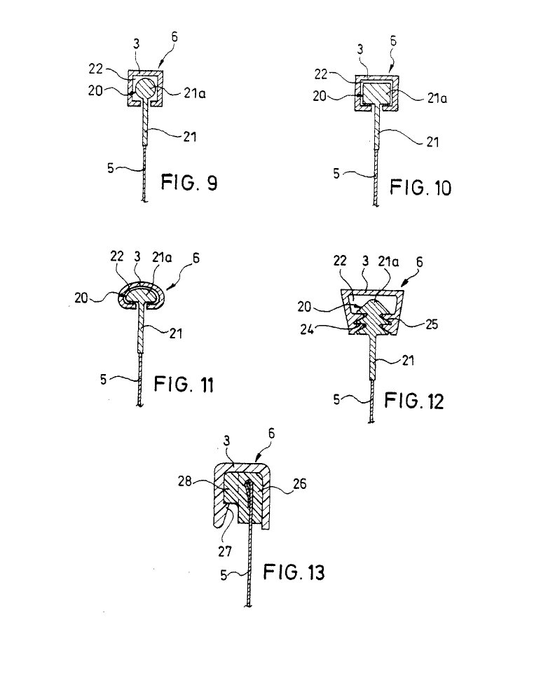

FIG. 9 shows a cross-sectional view of a connecting device according to an eighth preferred exemplary embodiment of the present invention;

FIG. 10 shows a cross-sectional view of a connecting device according to a ninth preferred exemplary embodiment of the present invention;

FIG. 11 shows a cross-sectional view of a connecting device according to a tenth preferred exemplary embodiment of the present invention;

FIG. 12 shows a cross-sectional view of a connecting device according to an eleventh preferred exemplary embodiment of the present invention;

FIG. 13 shows a cross-sectional view of a connecting device according to a twelfth preferred exemplary embodiment of the present invention;

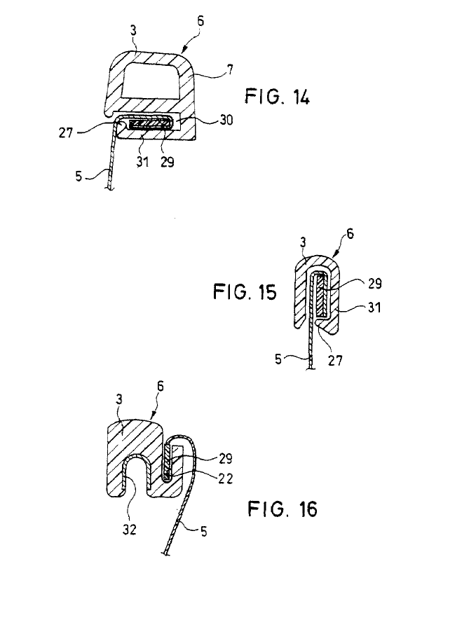

FIG. 14 shows a cross-sectional view of a connecting device according to a thirteenth preferred exemplary embodiment of the present invention;

FIG. 15 shows a cross-sectional view of a connecting device according to a fourteenth preferred exemplary embodiment of the present invention;

FIG. 16 shows a cross-sectional view of a connecting device according to a fifteenth preferred exemplary embodiment of the present invention;

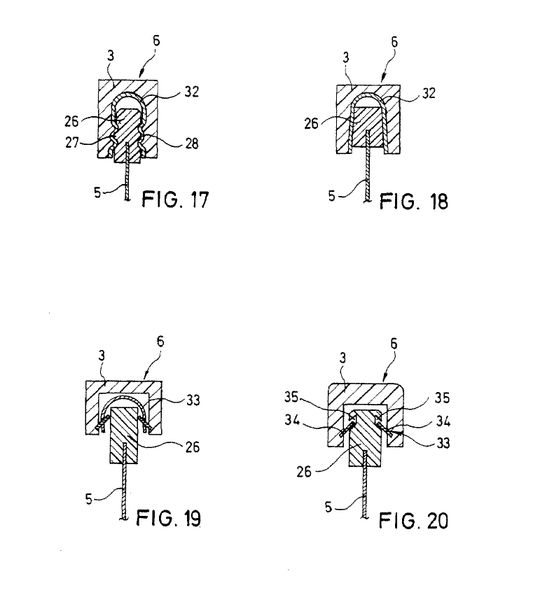

FIG. 17 shows a cross-sectional view of a connecting device according to a sixteenth preferred exemplary embodiment of the present invention;

FIG. 18 shows a cross-sectional view of a connecting device according to a seventeenth preferred exemplary embodiment of the present invention;

FIG. 19 shows a cross-sectional view of a connecting device according to an eighteenth preferred exemplary embodiment of the present invention;

FIG. 20 shows a cross-sectional view of a connecting device according to a nineteenth preferred exemplary embodiment of the present invention;

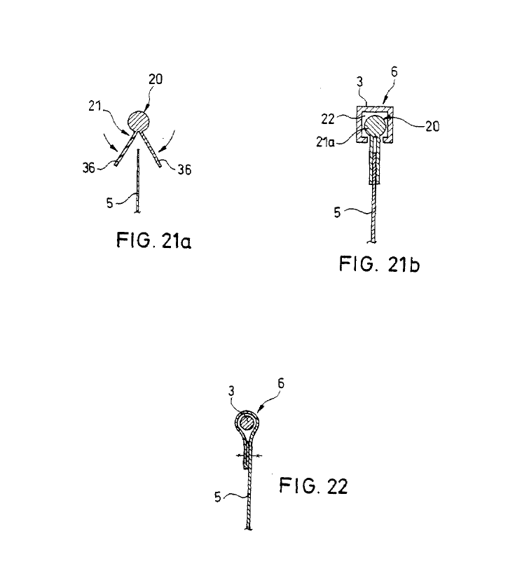

FIG. 21a shows a cross-sectional view of a component of a connecting device according to a twentieth preferred exemplary embodiment of the present invention in an open position;

FIG. 21b shows a cross-sectional view of the connecting device from FIG. 21a in a closed position; and

FIG. 22 shows a cross-sectional view of a connecting device according to a twenty-first preferred exemplary embodiment of the present invention.

In the figures of the drawing, the same reference numbers refer to identical or functionally identical components unless stated to the contrary.

FIG. 1 illustrates a partial section of a wind deflector 1 according to one exemplary embodiment of the present invention. As is apparent in FIG. 1, the wind deflector 1 comprises a base element 2 which can be fastened, for example, to an installation frame of a roof opening. The roof opening can be closed by a cover of a sliding roof. The base element 2 is composed, for example, of plastic, has an approximately U-shaped configuration and is fitted along the front edge and at least partially along the lateral edges of the roof opening.

The wind deflector 1 furthermore has a likewise U-shaped deployment element 3 which is provided in a manner such that it can pivot relative to the base element 2 between a storage position and a deployed position via a pivoting device 4. For example, the deployment element 3 is coupled pivotably to the base element 2.

In addition, a deflector element 5 is provided between the base element 2 and the deployment element 3, said deflector element being composed, for example, of a flexible and air-permeable material, for example of a fabric or an air-permeable plastic sheet or the like. The deflector element 5 is coupled to the base element 2 and the deployment element 3 in such a manner that, when the deployment element 3 is deployed, the deflector element 5 is tensioned between the base element 2 and the deployment element 3, as illustrated in FIG. 1.

Various preferred exemplary embodiments for different connections of the deflector element 5 to the base element 2 and/or to the deployment element 3 are explained in more detail below with reference to FIGS. 2 to 23.

Although the exemplary embodiments below describe a connection of the deflector element 5 to the deployment element 3, the connection variants indicated can also be transferred in an analogous manner to a connection of the deflector element 5 to the base element 2.

FIGS. 2a and 2b illustrate a connecting device 6 for a fastening of the deflector element 5 to the base element 2 and/or to the deployment element 3 according to a first preferred exemplary embodiment of the present invention, with FIG. 2a illustrating a cross-sectional view of the connecting device 6 in an open position and FIG. 2b illustrating a cross-sectional view of the connecting device 6 in the closed position, i.e. in a state clamping the deflector element 5.

The deployment element 3 is preferably produced as a plastic strip by means of an injection-molding process, the deployment element 3 according to the present example having a fixed base region 7 and a pivoting region 9 which is integrally formed pivotably on the base region 7 via, for example, a film hinge 8 which is injection-molded thereon at the same time. The base region 7 advantageously has a plurality of plug-in openings 10 which are spaced apart from one another in the longitudinal direction and into which complementarily associated plug-in pins 11 of the pivoting region 9 can be fixedly plugged in during a movement of the pivoting region 9 in the direction of the arrow illustrated in FIG. 2a.

As is apparent in FIG. 2b, the deflector element 5 is preferably aligned in the clamping region 12 between the base element 7 and the pivoting region 9 of the connecting device 6 and is fixedly clamped between the two regions 7 and 9 by pressing of the plug-in pins 11 into the associated plug-in openings 10. The plug-in openings 10 and the plug-in pins 11 are preferably designed to be complementary to one another in such a manner that a form-fitting and frictional connection between the base region 7 and the pivoting region 9 of the connecting device 6 is produced so as to firmly clamp the deflector element 5.

The plug-in pins 11 explained above can also be designed, for example, in the form of a plug-in strip running continuously in the longitudinal direction. The deflector element 5 can thereby be releasably fastened to the deployment element 3, which is advantageous in the event of maintenance. A disadvantageous injection-molding process can advantageously be dispensed with.

FIGS. 3a and 3b illustrate a connecting device 6 according to a second preferred exemplary embodiment of the present invention. According thereto, the connecting device 6 is formed with a two-part base region, comprising the individual parts 14 and 15, with the individual part 14 having a plurality of plug-in pins 11 and the individual part 15 having plug-in openings 10 formed in a complementary manner with respect thereto. The two individual parts 14, 15 are preferably composed of plastic.

Analogously to the previous first exemplary embodiment, the deflector element 5 is clamped between the two individual parts 14 and 15, with the plug-in pins 11 ensuring the corresponding clamping action.

Analogously to the previous exemplary embodiment, the plug-in pins 11 in turn can be designed as a plug-in strip running continuously in the longitudinal direction.

For the two individual parts 14 and 15 to be held together, the latter, as illustrated in FIG. 3b, are, for example, pushed or plugged into a U-shaped profile 16 in a form-fitting and frictional manner. The profile 16 can be composed, for example, of plastic or aluminum.

The deflector element 5 can therefore be directly clamped between the two individual parts 14 and 15, with the two individual parts 14 and 15 being held together by the U-shaped profile 16 in order to bring about the desired clamping force.

According to a third exemplary embodiment of the present invention, the operative connection between the two individual parts 14 and 15 can also be ensured in that the plug-in pins 11 have barbs 17 in such a manner that the individual parts 14 and 15 are connected to each other by latching of the plug-in pins 11 into the associated plug-in openings 10. In such a case, the U-shaped profile 16 may be omitted under some circumstances, as illustrated in FIGS. 4a and 4b. Again, a plug-in strip with latching devices or barbs instead of the individual plug-in pins may also be used.

FIG. 5 illustrates a cross-sectional view of a connecting device 6 according to a fourth preferred exemplary embodiment of the present invention. According to the present exemplary embodiment, the deployment element 3 comprises an injection-molded part made of, for example, plastic. The deployment element 3 forms the base region and serves to form the rigidity of the arrangement. The deployment element 3 furthermore has a cutout 18 which runs in the longitudinal direction and into which an associated clamping strip 19 can be plugged, pushed in and/or latched, such that the deflector element 5 is clamped between the clamping strip 19 and the deployment element 3, as illustrated in FIG. 5.

The clamping strip 19 is produced, for example, as a flexible extrusion part and is preferably designed as a continuous strip.

In the abovementioned exemplary embodiments, the deflector element 5 is accordingly releasably clamped directly to the deployment element 3 and to the base element 2 by means, for example, of clamping, latching pins, latching strips, wedging elements, clamping elements or the like. This advantageously makes a disadvantageous injecting of the deflector element 5 into the deployment element 3 and the base element 2 unnecessary.

Instead of a direct connection, the deflector element 5 can also be connected indirectly via a connecting element 20 to the deployment element 3 and the base element 2, this being evaluated in more detail below with explanation of a plurality of exemplary embodiments.

FIG. 6 illustrates a cross-sectional view of a connecting device 6 according to a fifth preferred exemplary embodiment. As illustrated in FIG. 6, the deflector element 5 is fixedly attached directly to the connecting element 20, for example by means of welding, adhesive bonding, sewing, injecting or the like.

The connecting element 20 here is designed, for example, as a profile which extends in the longitudinal direction and has a connecting section 21 and a head section 21a. For example, the connecting element 20 is designed as a cable, wire or elastic round profile which can be plugged, pushed, clipped or the like into a complementary receiving section 22 of the deployment element 3. The receiving section 22 preferably has a receiving section 22 which is complementary to the cross-sectional profile of the head section 21a of the connecting element 20 so as to stably receive the same, as is apparent in FIG. 6. This ensures a reliable and fixed attachment of the attachment element 20 and therefore of the deflector element 5 to the deployment element 3.

FIG. 7 illustrates a further preferred exemplary embodiment, wherein, in contrast to the preceding exemplary embodiment, the deflector element 5 is clamped to the connecting section 21 of the connecting element 20 by means of a clamping section 23. Of course, a different connection, for example welding, sewing, adhesive bonding, injection or the like is also conceivable in this case.

FIG. 8 illustrates a cross-sectional view of a connecting device 6 according to a seventh preferred exemplary embodiment of the present invention. In this case, the deflector element 5 is looped around an elastic connecting element 20 or an elastic cable, wire or the like and is subsequently sewn, adhesively bonded, welded or injected thereon. The connecting element 20 can subsequently be pushed, threaded, plugged, clipped or the like into a complementary receiving section 22 of the deployment element 3 analogously to the exemplary embodiments according to FIGS. 6 and 7.

FIGS. 9 to 12 illustrate various exemplary embodiments for the configuration of the connecting element 20. According to FIG. 9, the head section 21a of the connecting element 20 is designed in cross section, for example, as a round profile which can be pushed into a polygonal receiving section 22 of the deployment element 3.

FIG. 10 illustrates a ninth exemplary embodiment, according to which the head section 21a of the connecting element 20 has a rectangular cross-sectional profile and can likewise, for example, be pushed into a complementary receiving section 22 of the deployment element 3 with a polygonal cross-sectional profile.

However, any other desired configurations of the head section 21a of the connecting element 20 are also conceivable, such as, for example, a mushroom-shaped configuration according to FIG. 11, which can likewise advantageously be pushed into a complementary receiving section 22 of the deployment element 3 or into a receiving section 22 of the deployment element 3 that is correspondingly suitably designed in a different manner.

FIG. 12 illustrates a cross-sectional view of a connecting device 6 according to an eleventh preferred exemplary embodiment. According to the eleventh exemplary embodiment, the head section 21a of the connecting element 20 is designed as a latching element with a plurality of latching sections 24 made of, for example, a hard or soft plastic. The connecting element 20 can be clipped into the deployment element 3, which has latching receptacles 25 of complementary design corresponding to the latching sections 24, for releasable connection to said connecting element, as illustrated in FIG. 12.

In the preceding exemplary embodiments according to FIGS. 9 to 12, the deflector element 5 is again attached to the connecting section 21 of the connecting element 20 by means of a clamping connection, adhesive bonding connection, welding connection, injection connection, seam connection or the like.

FIG. 13 illustrates a cross-sectional view of a connecting device 6 according to a twelfth preferred exemplary embodiment of the present invention. According to this exemplary embodiment, the deflector element 5 is surrounded by means of a suitable plastic or the like by injection molding, with the injection-molded surround 26 advantageously forming the connecting element in this case.

In this case, the deployment element 3 preferably has an approximately U-shaped cross-sectional profile made of steel, aluminum or the like. The deployment element 3 is preferably designed as a spring-elastic clip connection with one or more latching lugs 27 which are spaced apart from one another in the longitudinal direction and, in the clipped-in state, engage in a latching manner behind an associated latching section 28 of the injection-molded surround 26, as illustrated in FIG. 13. As a result, the deflector element 5 can be releasably clipped into the deployment element 3 in a simple and cost-effective manner via the injection-molded surround 26.

FIG. 14 illustrates a cross-sectional view of a connecting device 6 according to a thirteenth preferred exemplary embodiment. According thereto, the deflector element 5 is sewn onto a plastic strip 29 or is fixedly connected to the plastic strip 29 in another manner.

The deployment element 3 is designed, for example, as a plastic profile with an integrally formed, spring-elastic tongue 31 which defines a receiving section 30. The strip 29 can be clipped or plugged into the receiving section 30 and is locked in place by means of the spring-elastic tongue 31. In this case, the spring-elastic tongue 31 can be designed as a tongue running continuously in the longitudinal direction, or a plurality of tongues can be provided in a manner spaced apart from one another in the longitudinal direction of the deployment element 3. The tongue or tongues 31 has/each have a latching lug 27 which engages in said manner behind the strip 27 in order to lock the same in place.

According to the exemplary embodiment according to FIG. 14, the deployment element 3 has a reinforced base region 7 on which the spring-elastic tongue 31 is integrally formed.

FIG. 15 illustrates a further exemplary embodiment of a connecting device 6, wherein, in contrast to the preceding exemplary embodiment, the deployment element 3 does not have a base region 7 but rather is designed as an approximately U-shaped receiving clip with an integrally formed tongue 31 and latching lug 27 for receiving the strip 29.

The plastic strip 29 may be attached to the deployment element 3 by means of a clamping connection, a wedge action connection, an adhesive bonding connection, a plug-in connection or the like instead of by means of a latching connection. According to FIG. 16, the plastic strip 29 is clamped into an associated receiving section 22 of the deployment element 3, with it being possible, for example, for a pivotable clip (not illustrated) to lock the strip 29 in the receiving section 22. The plastic strip 29 can also be wedged in the receiving section 22 or attached in some other way.

The deployment element 3 has, for example in its base region, a stiffening element 32 which is preferably designed as a U-shaped metal profile. The rest of the deployment element 3 is preferably formed from plastic or the like analogously to the preceding exemplary embodiments.

According to a further preferred exemplary embodiment of the present invention, the injection-molded surround 26 is coupled to the deployment element 3 in the region of the stiffening element 32. According to FIG. 17, the injection-molded surround 26 has a plurality of latching lugs 27 which engage in complementary latching notches 28 of the stiffening element 32, as illustrated in FIG. 17.

According to FIG. 18, the injection-molded surround 26 is preferably clamped or wedged into the stiffening element 32, thus ensuring a form-fitting and/or frictional connection.

FIG. 19 illustrates a connecting device 6 according to an eighteenth preferred exemplary embodiment of the present invention in a cross-sectional illustration. The deployment element 3 is produced, for example, as a U-shaped clip made of metal or a suitable plastic. The deployment element 3 has a retaining device 33, preferably made of metal or the like, which can be brought into engagement with the injection-molded surround 26 for connection of the same. The retaining device 33 can be designed in a very wide variety of ways as long as a stable attachment of the injection-molded surround 26 to the deployment element 3 is ensured via the retaining device 33. For example, a snap-in connection is realized by the retaining device 33.

The retaining device 33 advantageously has two retaining clips 34 which, for connection of the injection-molded surround 26, latch into associated latching notches 35 in the periphery of the injection-molded surround 26, as illustrated in FIG. 20 with reference to a further preferred exemplary embodiment. For example, owing to its U-shaped configuration, the deployment element 3 is configured in a spring-elastic manner such that the injection-molded surround 26 can be pressed or snapped into a latched state via the retaining device 33, as illustrated in FIG. 20.

It is obvious to a person skilled in the art that use can be made of any other retaining arrangements which ensure a releasable connection of the injection-molded surround 26 to the deployment element 3.

Instead of a fixed connection of the deflector element 5 to the connecting element 20, as is the case in the preceding exemplary embodiments, the deflector element 5 can also be releasably fastened to the connecting element 20. For example, the connection section 21 of the connecting element 20 has two clamping arms 36 which can be pivoted in the direction of the arrows illustrated in FIG. 21a and are connected fixedly to each other to firmly clamp the deflector element 5 between them. For example, after the deflector element 5 is fitted between them, the clamping arms 36 can be latched to each other, welded, adhesively bonded, injection-molded or coupled to each other in another manner.

As illustrated in FIG. 21b, the head section 21a of the connecting element 20 is pressed, pushed or the like into an associated and suitably designed receiving section 22 of the deployment element 3 analogously to the exemplary embodiments already described previously.

With regard to the further properties of the connecting element 20 and of the receiving section 22 of the deployment element 3, reference is made to the details above in order to avoid repetitions.

FIG. 22 illustrates a further exemplary embodiment for connection of the deflector element 5 to the deployment element 3. According to the present exemplary embodiment, the deployment element 3 is designed, for example, as a bar-shaped clip about which the deflector element is placed and is subsequently preferably sewn. Of course, instead of a seam connection, an adhesive bonding connection, welding connection or the like is again also conceivable.

The deflector element according to the present invention can therefore be attached both to the base element and to the deployment element in each case by means of a retaining device, latching elements, if appropriate with notches or latching receptacles provided therein, clamping elements or wedging elements, clamping of the deflector element in conjunction with pins or wedges provided, or by fixed connection by means of welding, adhesive bonding, sewing or the like.

Although the present invention has been described above with reference to preferred exemplary embodiments, it is not restricted thereto but rather can be modified in diverse ways.

For example, the deployment element or the base element can be designed as U-shaped clip with a hard component or component reinforced by means of a metal insert, and with a soft component integrally formed thereon, with the deflector element preferably being fastened to the soft component by means of sewing, adhesive bonding, welding, injecting or the like.

It is obvious to a person skilled in the art that, although the present exemplary embodiments have been described with reference to the deployment element, the present inventive concept can be applied analogously to a connection of the deflector element to the base element. Furthermore, the abovementioned embodiments can be combined with one another as desired, i.e. one or more of the abovementioned variants can be used for connecting of the deflector element to the deployment element and one or more of the above variants can likewise be used for connecting the deflector element to the base element, which variants may differ from one another.

### List of Reference Numbers

1 Wind deflector
2 Base element
3 Deployment element
4 Pivoting device
5 Deflector element
6 Connecting device
7 Base region
8 Film hinge
9 Pivoting region
10 Plug-in opening
11 Plug-in pin
12 Clamping region
14 Individual part
15 Individual part
16 Profile
17 Barb
18 Cutout
19 Clamping strip
20 Connecting element
21 Connecting section
21a Head section
22 Receiving section
23 Clamping section
24 Latching section
25 Latching receptacle
26 Injection-molded surround
27 Latching lug
28 Latching section
29 Strip
30 Receiving section
31 Tongue
32 Stiffening element
33 Retaining device
34 Clip
35 Latching notches
36 Clamping arm
37 Metal profile
38 Metal profile

1. A wind deflector in the motor vehicle sector, with:
a base element which can be attached to a motor vehicle part;
a deployment element which is mounted pivotably relative to the base element;
an adjusting device for pivoting the deployment element between a storage position and a deployed position; and with
a deflector element which can be attached to the base element and to the deployment element in order to tension the deflector element between the same in the deployed position of the deployment element;
wherein the deflector element can be fastened to the base element and/or to the deployment element by means of a releasable connection.

2. The wind deflector of claim 1, characterized in that the deflector element can be releasably attached directly to the base element and/or to the deployment element by means of a clamping device.

3. The wind deflector of claim 2, characterized in that the clamping device is designed as a plastic part with a film hinge injection-molded onto it in order to form a clamping strip.

4. The wind deflector of claim 2, characterized in that the clamping device is designed as a two-part clamping part for clamping the deflector element between the two individual parts.

5. The deflector element of claim 4, characterized in that the two individual parts of the clamping device can be joined together and, when joined together, can be locked in place in order to clamp the deflector element between them.

6. The wind deflector of claim 4, characterized in that the two individual parts of the clamping device can be pushed or plugged into an associated profile strip so as to maintain the joined state.

7. The wind deflector of claim 4, characterized in that the one individual part of the two-part clamping part has plug-in pins and the other individual part of the two-part clamping part has plug-in openings, it being possible for the plug-in pins to be plugged into associated plug-in holes in order to clamp the deflector element.

8. The deflector element of claim 2, characterized in that the clamping device is designed as a clamping strip which can be plugged on and/or pushed in, for clamping the deflector element between the clamping strip and the base element or the deployment element.

9. The wind deflector of claim 1, characterized in that the deflector element can be releasably fastened to the base element and/or to the deployment element indirectly via a connecting element.

10. The wind deflector of claim 9, characterized in that the deflector element is fixedly sewn, adhesively bonded, welded, injection-molded or the like to the connecting element.

11. The wind deflector of claim 9, characterized in that the deflector element can be releasably fastened to the connecting element, for example by means of clamping or the like.

12. The wind deflector of claim 9, characterized in that the connecting element can be attached to the base element and/or to the deployment element by means of a plug-in connection, clamping connection, wedge action connection, expanding connection, retaining connection, latching connection or the like.
